(19) United States
(12) Patent Application Publication
(10) Pub. No.: US 2024/0296227 A1
(43) Pub. Date: Sep. 5, 2024

(54) SYSTEMS AND METHODS TO PREVENT CLONING ON SPDM-ENABLED DEVICES

(71) Applicant: Dell Products, L.P., Round Rock, TX (US)

(72) Inventors: Vineeth Radhakrishnan, Palakkad (IN); Mini Thottunkal Thankappan, Bangalore (IN); Shinose Abdul Rahiman, Bangalore (IN); Rama Rao Bisa, Bangalore (IN); Dharma Bhushan Ramaiah, Bangalore (IN)

(73) Assignee: Dell Products, L.P., Round Rock, TX (US)

(21) Appl. No.: 18/177,151

(22) Filed: Mar. 2, 2023

(51) Int. Cl. G06F 21/57; H04L 9/32

(52) U.S. Cl. CPC G06F 21/572; H04L 9/3265; H04L 9/3271; G06F 2221/033

(57) ABSTRACT

According to embodiments of the present disclosure, a firmware cloning prevention system and method provided using Security Protocol and Data Model (SPDM)-enabled devices. The firmware cloning prevention system and method include program instructions that may be executed on a processing system to determine, by a first node configured in a certificate chain as specified by the SPDM specification, that a second node in the certificate chain possesses a private key stored on the ensuing node, perform a challenge-response verification to establish proof of possession of the private key, and inhibit operation of the ensuing node based upon the challenge-response verification. The second node is the next sequential node of the certificate chain.

### BACKGROUND

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

Communication networks, and in particular the Internet, has revolutionized the manner in which software is updated on a computer system. Prior to the advent of the Internet, a software provider would package the update on computer readable media, and the computer owner had to obtain a copy of the media to complete the update in order to make the software update accessible to the user of the computer system. However, distributing software updates on computer readable media was often expensive for software providers, which tended to restrict the number of software updates that a software provider would issue. As a consequence, substantial time would pass between updates, and consumers had to manage certain known issues for these time periods, at least until an update became available. Another aspect of this older method was that many modifications were packaged into a single update to reduce the costs associated with distributing the update.

SPDM-based attestation, which has been published by the Platform Management Components Intercommunication (PMCI) Working Group of the Distributed Management Task Force (DMTF), generally involves a security mechanism to remotely detect an adversarial presence on a device to guarantee the device's trustworthiness. Attestation runs as a two-party security scheme in which a trusted party (e.g., the requesting device) assures the integrity of the untrusted remote device (e.g., the responding device). A requesting device, using this scheme, can determine the identity of a device and/or the firmware/software that the device is running. The responding device may send proof about its current state using a cryptographic hash to the requesting device. The requesting device may then evaluate the received evidence with the expected legitimate state of the responding device, and validate whether or not the responding device is trustworthy or not. Many system-on-chip (SOC) platforms now use SPDM-based attestation due in large part, to its light weight and high levels of security provided thereby.

### SUMMARY

According to embodiments of the present disclosure, a firmware cloning prevention system and method provided using Security Protocol and Data Model (SPDM)-enabled devices. The firmware cloning prevention system and method include program instructions that may be executed on a processing system to determine, by a first node configured in a certificate chain as specified by the SPDM specification, that a second node in the certificate chain possesses a private key stored on the ensuing node, perform a challenge-response verification to establish proof of possession of the private key, and inhibit operation of the ensuing node based upon the challenge-response verification. The second node is the next sequential node of the certificate chain.

According to another embodiment, a firmware cloning prevention method includes the steps of determining, by a first node configured in a certificate chain, that a second node in the certificate chain possesses a private key stored on the ensuing node, wherein the second node is the next sequential node of the certificate chain, performing a challenge-response verification to establish proof of possession of the private key, and inhibiting operation of the ensuing node based upon the challenge-response verification.

According to yet another embodiment, a computer program product includes computer-executable instructions to determine, by a first node configured in a certificate chain, that a second node in the certificate chain possesses a private key stored on the ensuing node, perform a challenge-response verification to establish proof of possession of the private key, and inhibit operation of the ensuing node based upon the challenge-response verification.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 shows an example of an Information Handling System (IHS) that may be configured to implement a system and method for collective attestation according to one embodiment of the present disclosure.

FIG. 2 illustrates an example certificate chain upon which embodiments of the firmware cloning prevention system and method may be implemented according to one embodiment of the present disclosure.

FIG. 3 illustrates an example firmware cloning prevention method that may be performed to prevent cloning of firmware on SPDM-enabled devices of an IHS according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below.

Certain IHSs may be configured with BMCs that are used to monitor, and in some cases manage computer hardware components of their respective IHSs. A BMC is normally programmed using a firmware stack that configures the BMC for performing out-of-band (e.g., external to a computer's operating system or BIOS) hardware management tasks. The BMC firmware can support industry-standard Specifications, such as the Intelligent Platform Management Interface (IPMI) and Systems Management Architecture of Server Hardware (SMASH) for computer system administration.

Baseboard management controllers (BMCs) are particularly well suited for the features provided by the Security Protocol and Data Model (SPDM) specification. The SPDM specification has been published by the Platform Management Components Intercommunication (PMCI) Working Group of the Distributed Management Task Force (DMTF). A particular goal of the SPDM specification is to facilitate secure communication among the devices of a platform management subsystem. Examples of a platform management subsystem may include an Information Handling System (IHS), such as a desktop computer, laptop computer, a cellular telephone, a server, and the like.

The SPDM specification defines messages and procedures for secure communication among hardware devices, which includes authentication of hardware devices and session key exchange protocols to provide secure communication among those hardware devices. Management Component Transport Protocol (MCTP) Peripheral Component Interconnect Express (PCIe) vendor defined message (VDM) channels, which supports peer-to-peer messaging (e.g., route by ID), allow a SPDM-enabled hardware device to issue commands to other SPDM-enabled hardware devices within a secure communication channel.

Cyber attackers are reportedly exploiting and abusing devices, such as platform interface protocol analyzers to steal unencrypted information, spy on network traffic, and gather information to leverage in future attacks against platform components and component interfaces (e.g., I2C, PCIe, I3C, Sensewire, SPI, etc.) of an IHS. Detection of vulnerable platform components is not an easy task, and exploiting unpatched vulnerabilities could allow the attacker to take control of the IHS. Some example platform security risks may include compromised security in which hostile component insertion and/or compromised firmware updates can cause supply chain security issues. Another example platform security risk may include confidentiality and integrity risks in which data transfers that are unencrypted may be vulnerable to eavesdropping, stealing, and tampering. Additionally, non-compliant security configuration errors, certificate management, platform security trust, and the like could lead to non-compliance with industry standard security policies. The DMTF SPDM specifications have been developed to alleviate such problems and reduce management overhead in maintaining and establishing the platform security within the IHS infrastructure domain.

Devices enabled by SPDM support provide enhanced trust compared to devices without SPDM support, as they provide cryptographic guarantees for the device identity and the firmware. In SPDM, trust is accomplished using certificate chains. A certificate chain generally includes a root certificate generated by a trusted root certificate authority and provisioned into a first node often referred to as an authentication initiator. Other nodes configured may be provisioned with secondary certificates referred to as device certs, which may include intermediate certificates corresponding to devices between the root certificate authority and a leaf certificate corresponding to the last node in the certificate chain.

In SPDM an alias certificate chain, a device certificate (e.g., DeviceCert) node is a transition node in the domain of control from a manufacturer infrastructure (e.g., vendor Facility) to a device's location (e.g., customer facility). For example, a BMC may be configured with a device cert, and administer alias certificates for authenticating firmware updates whose certificates may change with each update. A hardware identity can be added in a trusted environment and the firmware update can happen in any location. Because of this, the alias certificate will be re-created whenever there is a firmware update in the device. Usually, a challenge-response may be used for proof of possession that a private key is used for a leaf node. In the alias certificate case however, a challenge-response may be needed for the device cert, which is an intermediate node in the certificate chain.

Even using SPDM, firmware vulnerabilities do occur. In case of a firmware vulnerability where the device certificate node (e.g., BMC) can sign alias nodes, this may create a path for an adversary to create cloned/counterfeit devices. In the current SPDM architecture, if a firmware vulnerability exists, it could be used to exploit the vulnerability to some, most, or all other BMCs.

For example, a root certificate can be trusted because the vendor takes care of signing the private key in their facility, and an intermediate certificate (e.g., provisioned at the vendor facility) can be trusted because the vendor takes care of signing the private key in their facility. In such a case, signing may be performed with processes to control usage and protection and with well-established organization controls. For a device certificate (e.g., provisioned in a BMC that monitors and controls the operation of multiple hardware devices configured in an IHS), however, the device instance has the responsibility to take care of the private key. Thus, trust need to be established with that device instance.

For alias certs, since the device has secure boot, the firmware used for deriving keys is trusted during the secure boot process. It is signed by a device certificate CA with which trust may not necessarily be established. Additionally, since the device has secure boot, the firmware used for deriving keys is trusted during the secure boot process. It is signed by an alias intermediate CA with which trust is not established. As will be described in detail herein below, embodiments of the present disclosure, systems and methods to prevent cloning of firmware with vulnerabilities are described in which a first node, such as a BMC, identifies that a second node in a certificate chain possesses a private key, and performs a performs challenge-response verification to establish proof of possession of the private key, and if the challenge-response fails, inhibits operation of the second node based upon the challenge-response verification. The solution may, for example, prevent counterfeits and damage by preventing exploits of firmware vulnerabilities.

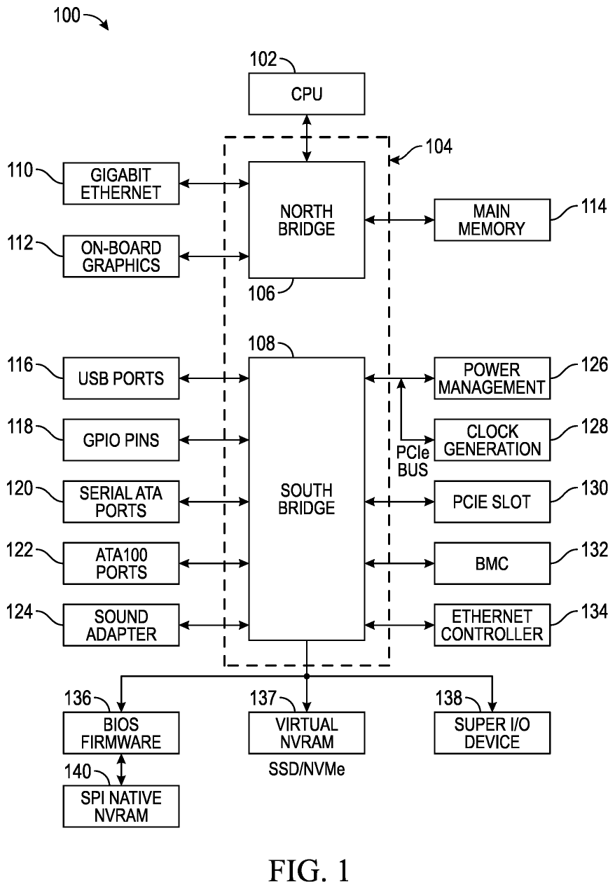

FIG. 1 shows an example of an IHS 100 that may be configured to implement embodiments described herein. It should be appreciated that although certain embodiments described herein may be discussed in the context of a desktop or server computer, other embodiments may be utilized with virtually any type of IHS 100. Particularly, the IHS 100 includes a baseboard or motherboard, to which is a printed circuit board (PCB) to which components or devices are mounted by way of a bus or other electrical communication path. For example, Central Processing Unit (CPU) 102 operates in conjunction with a chipset 104. CPU 102 is a processor that performs arithmetic and logic necessary for the operation of the IHS 100.

Chipset 104 includes northbridge 106 and southbridge 108. Northbridge 106 provides an interface between CPU 102 and the remainder of the IHS 100. Northbridge 106 also provides an interface to a random access memory (RAM) used as main memory 114 in the IHS 100 and, possibly, to on-board graphics adapter 112. Northbridge 106 may also be configured to provide networking operations through Ethernet adapter 110. Ethernet adapter 110 is capable of connecting the IHS 100 to another IHS (e.g., a remotely located IHS 100) via a network. Connections which may be made by Ethernet adapter 110 may include local area network (LAN) or wide area network (WAN) connections. Northbridge 106 is also coupled to southbridge 108.

Southbridge 108 is responsible for controlling many of the input/output (I/O) operations of the IHS 100. In particular, southbridge 108 may provide one or more universal serial bus (USB) ports 116, sound adapter 124, Ethernet controller 134, and one or more general purpose input/output (GPIO) pins 118. Southbridge 108 may also provide a bus for interfacing peripheral card devices such as PCIe slot 130. In some embodiments, the bus may include a peripheral component interconnect (PCI) bus. Southbridge 108 may also provide baseboard management controller (BMC) 132 for use in managing the various components of the IHS 100. Power management circuitry 126 and clock generation circuitry 128 may also be utilized during operation of southbridge 108.

Additionally, southbridge 108 is configured to provide one or more interfaces for connecting mass storage devices to the IHS 100. For instance, in an embodiment, southbridge 108 may include a serial advanced technology attachment (SATA) adapter for providing one or more serial ATA ports 120 and/or an ATA100 adapter for providing one or more ATA100 ports 122. Serial ATA ports 120 and ATA100 ports 122 may be, in turn, connected to one or more mass storage devices storing an operating system (OS) and application programs.

An OS may comprise a set of programs that controls operations of the IHS 100 and allocation of resources. An application program is software that runs on top of the OS and uses computer resources made available through the OS to perform application-specific tasks desired by the user.

Mass storage devices connected to southbridge 108 and PCIe slot 130, and their associated computer-readable media provide non-volatile storage for the IHS 100. Although the description of computer-readable media contained herein refers to a mass storage device, such as a hard disk or CD-ROM drive, it should be appreciated by a person of ordinary skill in the art that computer-readable media can be any available media on any memory storage device that can be accessed by the IHS 100. Examples of memory storage devices include, but are not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices.

A low pin count (LPC) interface may also be provided by southbridge 108 for connecting Super I/O device 138. Super I/O device 138 is responsible for providing a number of I/O ports, including a keyboard port, a mouse port, a serial interface, a parallel port, and other types of input/output ports.

The LPC interface may connect a computer storage media such as a ROM or a flash memory such as a non-volatile random access memory (NVRAM) for storing BIOS/firmware 136 that includes BIOS program code containing the basic routines that help to start up the IHS 100 and to transfer information between elements within the IHS 100. BIOS/firmware 136 comprises firmware compatible with the Extensible Firmware Interface (EFI) Specification and Framework.

The LPC interface may also be utilized to connect virtual NVRAM 137 (e.g., SSD/NVMe) to the IHS 100. The virtual NVRAM 137 may be utilized by BIOS/firmware 136 to store configuration data for the IHS 100. In other embodiments, configuration data for the IHS 100 may be stored on the same virtual NVRAM 137 as BIOS/firmware 136. The IHS 100 may also include a SPI native NVRAM 140 coupled to the BIOS 136.

BMC 132 may include non-volatile memory having program instructions stored thereon that enable remote management of the IHS 100. For example, BMC 132 may enable a user to discover, configure, and manage the IHS 100, setup configuration options, resolve and administer hardware or software problems, etc. Additionally or alternatively, BMC 132 may include one or more firmware volumes, each volume having one or more firmware files used by the BIOS' firmware interface to initialize and test components of the IHS 100.

As a non-limiting example of BMC 132, the integrated DELL Remote Access Controller (iDRAC) from DELL, INC. is embedded within DELL POWEREDGE servers and provides functionality that helps information technology (IT) administrators deploy, update, monitor, and maintain servers with no need for any additional software to be installed. The iDRAC works regardless of OS or hypervisor presence from a pre-OS or bare-metal state because iDRAC is embedded within the IHS 100 from the factory.

It should be appreciated that, in other embodiments, the IHS 100 may comprise other types of computing devices, including hand-held computers, embedded computer systems, personal digital assistants, and other types of computing devices. It is also contemplated that the IHS 100 may not include all of the components shown in FIG. 1, may include other components that are not explicitly shown in FIG. 1, or may utilize a different architecture.

According to embodiments of the present disclosure, the IHS 100 may support SPDM in which the BMC 132 manages the operation of one or more managed devices configured in the IHS 100. The SPDM specification provides for secure communication between the BMC 132 and the managed devices in the IHS 100. To meet this goal, the SPDM specification facilitates certificate chains that are stored in up to eight slots. Slot 0 is a default slot that is always used, while the other slots (e.g., slots 1-7) may be allocated for use by the administrator of the IHS 100. The SPDM spec also provides a slot mask that identifies each certificate chain.

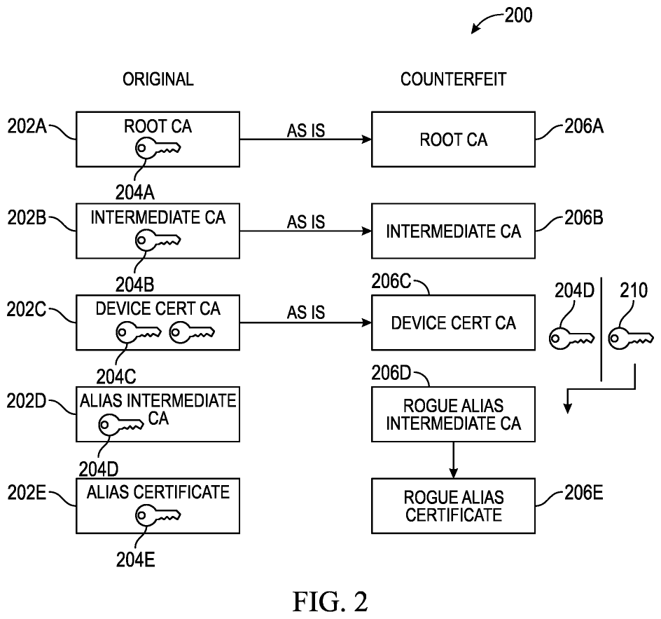

FIG. 2 illustrates an example certificate chain 200 upon which embodiments of the firmware cloning prevention system and method may be implemented according to one embodiment of the present disclosure. The certificate chain 200 includes multiple nodes 202a-e (collectively 202) including a root CA node 202a, an intermediate node 202b, a device certificate CA node 202c, an alias intermediate CA node 202d, and an alias certificate node 202e.

In one embodiment, the nodes 202a-e may correspond to nodes of a chain associated with a computing device or server (e.g., IHS 100) provided by a vendor to a user (e.g., customer) of the IHS 100. For example, the root CA node 202a may be a vendor of the IHS 100 and may possess a root certificate key 204a that may be used to sign an intermediate certificate key 204b stored in the intermediate CA node 202b. The intermediate certificate key 204b, in turn, may be used to sign a device certificate key 204c stored in device certificate node 202c, which in the present embodiment, may be a BMC 132. The device certificate key 204c, in turn, may be used to sign an alias intermediate certificate key 204d associated with the alias intermediate certificate node 202d, which in the present embodiment, may be an alias node that is re-created whenever there is a firmware update in the device represented by the alias certificate node 202e. The alias intermediate certificate key 204d, in turn, may be used to sign an alias certificate key 204e associated with the alias certificate node 202e, which in the present embodiment, may be the firmware update to a component (e.g., SPDM-enabled device) in the IHS 100.

The certificate chain 200 may possess certain potential counterfeit certificates 206a-e that can be potentially generated. For example, the certificate chain 200 includes a root CA node 202a that may, for example, correspond to a vendor facility and is, in many cases well protected. Sequentially aligned after the root CA node 202a is the intermediate CA node 202b that may correspond to a vendor facility certificate that is commonly used for signing device certificates. Somewhat similar to the root CA node 202a, the intermediate CA node 202b is relatively well protected because it is typically maintained with established organizational controls. Thus, a relatively low likelihood exists of generating rogue certificates 206a-e for the root CA node 202a, intermediate CA node 202b, and/or device node 202c.

Sequentially aligned after the intermediate CA node 202b is the device certificate CA node 202c, which may be associated, for example, with a BMC 132 that administers the operation of the components of an IHS 100. Because a BMC 132 does not exist under the immediate control of its vendor due to its deployment at a customer site, a rogue private key 210 can be used to replace the original private key (e.g., alias intermediate CA certificate 204d). Without a challenge-response verification, the alias intermediate CA certificate 204d cannot be verified, and cannot guarantee proof of possession of the private key. Thus, rogue firmware in a rogue device with malicious functionality may be camouflaged as a genuine vendor device. For example, a much higher likelihood exists to generate rogue or counterfeit certificates 206a-e for nodes 202d-e, than it would be to generate rogue or counterfeit certificates for nodes 202a-c.

Conventionally, the SPDM specification has not provided for providing a challenge-response in device certificate nodes, such as device certificate CA node 202c, thus leaving downstream nodes (e.g., 202d and 202e) vulnerable to attack. According to embodiments of the present disclosure, when a device certificate node 202c recognizes that the alias intermediate CA node 202d possesses a private key 204d stored in that node, it performs a challenge-response verification to establish proof of possession of the private key, and inhibits operation of the alias intermediate CA node 202d based upon the challenge-response verification. For example, if the device certificate node 202c determines that the challenge-response verification passes, it continues to let the alias intermediate CA node 202d sign the alias certificate node 202e. In the case in which the alias certificate node 202e is a firmware update, it is allowed to be deployed on its associated SPDM-enabled device of the IHS 100. If, however, the device certificate node 202c determines that the challenge-response verification fails, it inhibits the alias intermediate CA node 202d from signing the alias certificate node 202e such that, for the example in which the alias certificate node 202e is a firmware update, inhibits the firmware update from being deployed on its associated component of the IHS 100.

The firmware cloning prevention system may be implemented with any suitable SPDM-enabled device that conforms to the SPDM specification. Examples of SPDM-enabled devices may include any SPDM-enabled device, such as on-board graphics adapter 112, Ethernet adapter 110, USB ports 116, sound adapter 124, Ethernet controller 134, GPIO pins 118, PCIe slot 130, Power management circuitry 126, clock generation circuitry 128, serial ATA ports 120, ATA100 ports 122, virtual NVRAM 137, SPI native NVRAM 140, and Super I/O device 138 as described herein above.

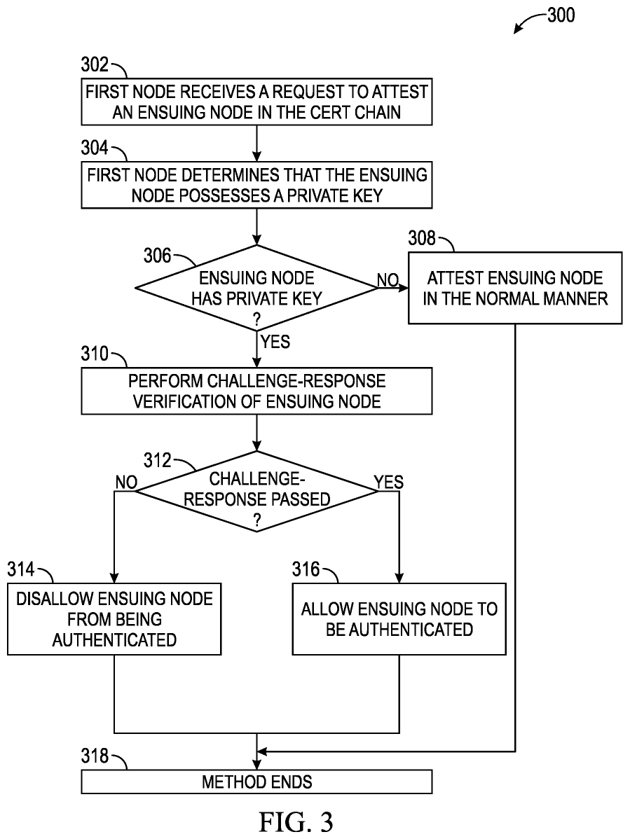

FIG. 3 illustrates an example firmware cloning prevention method 300 that may be performed to prevent cloning of firmware on SPDM-enabled devices of an IHS 100 according to one embodiment of the present disclosure. Additionally or alternatively, the firmware cloning prevention method 300 may be performed at least in part, using the certificate chain as described herein above with reference to FIG. 2. The firmware cloning prevention method 300 may be performed at any suitable time, such as whenever a SPDM-enabled device is to be updated with new firmware. Additionally, the method 300 may be performed by any node 202 in a certificate chain 200, such as a certificate chain associated with multiple nodes of an IHS 100 extending from the vendor of the IHS 100 to a user (e.g., customer) of the IHS 100.

Initially at step 302, a first node configured in a certificate chain receives a request to attest an ensuing node in the certificate chain. For example, the first node may be a BMC 132 that has been previously attested by a previous CA (e.g., intermediate CA node 202b), and the previous CA requests that it attest a particular ensuing node, such as an alias intermediate node 202d. Thereafter at step 304, the first node determines that the ensuing node possesses (e.g., stores) a private key. In one embodiment, the first node may identify a policy Organization Identify (OID) that indicates that the ensuing node possesses (e.g., stores) the private key at step 306. If the ensuing node does not have the private key, processing continues at step 308 in which the first node attests the ensuing node in the normal manner, and continues at step 318 in which the method 300 ends. If, however, the ensuing node does have the private key, the first node performs a challenge-response verification of the ensuing node at step 310.

At step 312, if the challenge-response verification does not pass, processing continues at step 314; otherwise, processing continues at step 316. At step 314, the first node disallows the ensuing node from being authenticated. In one embodiment, the first node may inhibit the ensuing node from deploying firmware update, for example, by inhibiting the ensuing node from authenticating any other downstream node, such as a firmware update. If the challenge-response verification passes, however, processing continues at step 316 in which the first node allows the ensuing node to be authenticated. In one embodiment, the first node may allow the ensuing node to deploy the firmware update by allowing the ensuing node to attest the firmware update.

When either of steps 314 or 316 have been performed, processing continues at step 318 in which the method ends. The aforedescribed firmware cloning prevention method 300 may be performed each time the certificate chain is to be authenticated. Nevertheless, when use of the firmware cloning prevention method 300 is no longer needed or desired, the method 300 ends.

Although FIG. 3 describes an example method 300 that may be performed to prevent firmware from being cloned on rogue devices, the features of the method 300 may be embodied in other specific forms without deviating from the spirit and scope of the present disclosure. For example, the method 300 may perform additional, fewer, or different operations than those described in the present examples. For another example, the method 300 may be performed in a sequence of steps different from that described above. As yet another example, certain steps of the method 300 may be performed by other components than those described above, such as by a BMC 132 configured in the IHS 100.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” when used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
at least one memory coupled to the at least one processor, the at least one memory having program instructions stored thereon that, upon execution by the at least one processor, cause the instructions to:
determine, by a first node configured in a certificate chain as specified by a Security Protocol and Data Model (SPDM) specification, that a second node in the certificate chain possesses a private key stored on the ensuing node, wherein the second node is the next sequential node of the certificate chain;
perform a challenge-response verification to establish proof of possession of the private key; and
inhibit operation of the ensuing node based upon the challenge-response verification.

2. The IHS of claim 1, wherein the first node comprises a Baseboard Management Controller (BMC), and the ensuing node comprises an alias intermediate Certificate Authority (CA).

3. The IHS of claim 2, wherein another node downstream on the certificate chain from the alias intermediate CA comprises a firmware update.

4. The IHS of claim 3, wherein the program instructions, upon execution, further cause IHS to:
inhibit operation of the ensuing node by disallowing the ensuing node from authenticating the firmware update when the challenge-response verification fails; and
allow the authentication of the firmware update when the challenge-response verification passes.

5. The IHS of claim 1, wherein the program instructions, upon execution, further cause IHS to identify a policy Organization Identifier (OID) stored in the ensuing node to determine that the ensuing node possesses the private key.

6. The IHS of claim 5, wherein the program instructions, upon execution, further cause IHS to attest the ensuing key in a normal manner when the ensuing node does not possess the private key.

7. The IHS of claim 1, wherein the certificate chain comprises a root CA node representing a vendor of a computing device.

8. The IHS of claim 7, wherein another node downstream on the certificate chain from the ensuing node comprises a firmware update, and wherein the firmware update is configured to be deployed on a SPDM-enabled device conforming to the SPDM specification.

9. A firmware cloning prevention method comprising:
determining, by a first node configured in a certificate chain as specified by a Security Protocol and Data Model (SPDM) specification, that a second node in the certificate chain possesses a private key stored on the ensuing node, wherein the second node is the next sequential node of the certificate chain;
performing a challenge-response verification to establish proof of possession of the private key; and
inhibiting operation of the ensuing node based upon the challenge-response verification.

10. The firmware cloning prevention method of claim 9, wherein the first node comprises a Baseboard Management Controller (BMC), and the ensuing node comprises an alias intermediate Certificate Authority (CA).

11. The firmware cloning prevention method of claim 10, wherein another node downstream on the certificate chain from the alias intermediate CA comprises a firmware update.

12. The firmware cloning prevention method of claim 11, further comprising:
inhibiting operation of the ensuing node by disallowing the ensuing node from authenticating the firmware update when the challenge-response verification fails; and
allowing the authentication of the firmware update when the challenge-response verification passes.

13. The firmware cloning prevention method of claim 9, further comprising identifying a policy Organization Identifier (OID) stored in the ensuing node to determine that the ensuing node possesses the private key.

14. The firmware cloning prevention method of claim 9, wherein the certificate chain comprises a root CA node representing a vendor of a computing device.

15. The firmware cloning prevention method of claim 14, wherein another node downstream on the certificate chain from the ensuing node comprises a firmware update, and wherein the firmware update is configured to be deployed on a SPDM-enabled device conforming to the SPDM specification.

16. A computer program product comprising a computer readable storage medium having program instructions stored thereon that, upon execution by an Information Handling System (IHS), cause the IHS to:
determine, by a first node configured in a certificate chain as specified by a Security Protocol and Data Model (SPDM) specification, that a second node in the certificate chain possesses a private key stored on the ensuing node, wherein the second node is the next sequential node of the certificate chain;
perform a challenge-response verification to establish proof of possession of the private key; and
inhibit operation of the ensuing node based upon the challenge-response verification.

17. The computer program product of claim 1, wherein the first node comprises a Baseboard Management Controller (BMC), the ensuing node comprises an alias intermediate Certificate Authority (CA), and another node downstream on the certificate chain from the alias intermediate CA comprises a firmware update.

18. The computer program product of claim 17, wherein the program instructions, upon execution, further cause computer program product to:
inhibit operation of the ensuing node by disallowing the ensuing node from authenticating the firmware update when the challenge-response verification fails; and
allow the authentication of the firmware update when the challenge-response verification passes.

19. The computer program product of claim 17, wherein the program instructions, upon execution, further cause computer program product to identify a policy Organization Identifier (OID) stored in the ensuing node to determine that the ensuing node possesses the private key.

20. The computer program product of claim 17, wherein the certificate chain comprises a root CA node representing a vendor of a computing device, and wherein another node downstream on the certificate chain from the ensuing node comprises a firmware update, and wherein the firmware update is configured to be deployed on a SPDM-enabled device conforming to the SPDM specification.
